(19) United States
(12) Patent Application Publication
(10) Pub. No.: US 2014/0254002 A1
(43) Pub. Date: Sep. 11, 2014

(54) Substrate for Controlling Light Transmission and Process for Manufacture Thereof

(71) Applicant: SABIC Innovative Plastics IP B.V., Bergen op Zoom (NL)

(72) Inventor: Tony Farrell, Bergen op Zoom (NL)

(21) Appl. No.: 14/195,258

(22) Filed: Mar. 3, 2014

Related U.S. Application Data
(60) Provisional application No. 61/774,896, filed on Mar. 8, 2013.

(51) Int. Cl. G02B 5/26; B23K 26/00

(52) U.S. Cl. CPC G02B 5/26; B23K 26/0066
USPC 359/360; 359/359; 29/428; 219/121.69

(57) ABSTRACT

A substrate for controlling the transmission of light therethrough has a light reflecting layer affixed to a light transmitting layer. The light reflecting layer is divided into a plurality of subdivisions arranged in a plurality of rows. Each subdivision has an area, is spaced apart from adjacent subdivisions, and has a different thickness than the light transmitting layer between the subdivisions. By controlling the size, spacing and thickness of the subdivisions and the thickness of the light reflecting layer between the subdivisions it is possible to control the light transmitted through and reflected from the substrate. A method of making the substrate by ablating the light reflecting layer is also disclosed.

### CROSS REFERENCE TO RELATED APPLICATION

This application is based upon and claims priority to U.S. Provisional Application No. 61/774,896, filed Mar. 8, 2013 and hereby incorporated by reference herein.

### FIELD OF THE INVENTION

This invention concerns substrates for limiting radiant heat transfer, and to methods for manufacturing such substrates.

### BACKGROUND

Light from the sun which reaches the surface of the earth comprises a spectrum of electromagnetic waves having wavelengths from about 200 nm to about 2,500 nm. The term “incident light” is used herein to describe this light and is defined herein as the spectrum of light having wavelengths from about 200 nm to about 2,500 nm. The incident light spectrum can be divided into three parts, ultraviolet light, which comprises a spectrum of electromagnetic waves having wavelengths from 200 nm to about 380 nm, visible light, which comprises a spectrum of electromagnetic waves having wavelengths from about 380 nm to about 780 nm and which is visible to the Atlanta #v1 human eye, and infrared light, a spectrum of electromagnetic waves having wavelengths from about 750 nm to about 2,500 nm. The term “visible light” is defined herein as the spectrum of light having wavelengths from about 380 nm to about 780 nm. The term “infrared light” is defined herein as the spectrum of light having wavelengths from about 780 nm to about 2,500 nm.

Approximately 50% of the solar energy which reaches the earth's surface is generated by infrared light. It is thus clear that environmental control of enclosed spaces, such as buildings and automotive interiors, which are subjected to incident light, can be accomplished more efficiently and with less energy if the transmission of infrared light into such interiors is controlled, i.e., limited or substantially blocked. Further advantages may be realized if the transmission of visible light is simultaneously controlled, but by allowing a large portion of the visible light to be transmitted into the interior. Thus, there is clearly a need for glazing material, for example in the form of a substrate, which can selectively limit or substantially block the transmission of heat producing (but invisible) infrared light while substantially permitting the transmission of desired visible light.

### SUMMARY

The invention concerns a substrate for controlling transmission of incident light therethrough, and incudes at least the following embodiments:

Example embodiment 1: A substrate for controlling transmission of incident light therethrough, the incident light including visible light and infrared light, the substrate comprising:
a light transmitting layer having a surface;
a light reflecting layer positioned on the surface of the light transmitting layer, the light reflecting layer having a layer thickness and comprising a plurality of subdivisions arranged adjacent to one another, each of the subdivisions having a subdivision thickness less than the layer thickness, each of the subdivisions having a surface area, each of the subdivisions being spaced from an adjacent subdivision by a spacing distance, the layer thickness, the subdivision thickness, the surface area and the spacing distance being arranged so as to permit transmission of from 15% to 75% of the visible light through the substrate.

Example embodiment 2: The substrate of embodiment 1, wherein the light reflecting layer comprises an infrared reflecting layer.

Example embodiment 3: The substrate of either embodiment 1 or 2, wherein the layer thickness, the subdivision thickness, the surface area and the spacing distance are arranged so as to permit transmission of from 18% to 73% of the visible light through the substrate.

Example embodiment 4: The substrate of any of embodiments 1-3, wherein the layer thickness, the subdivision thickness, the surface area and the spacing distance are arranged so as to permit transmission of from 20% to 80% of the incident light through the substrate.

Example embodiment 5: The substrate of any of embodiments 1-4, wherein the layer thickness, the subdivision thickness, the surface area and the spacing distance are arranged so as to permit transmission of from 15% to 70% of the incident light through the substrate.

Example embodiment 6: The substrate of any of embodiments 1-3, wherein the layer thickness, the subdivision thickness, the surface area and the spacing distance are arranged so as to cause from 20% to 80% of the incident light to be reflected from the substrate.

Example embodiment 7: The substrate of any of embodiments 1-6, wherein the layer thickness, the subdivision thickness, the surface area and the spacing distance are arranged so as to give a light to solar gain ratio greater than one.

Example embodiment 8: The substrate of any of embodiments 1-7, wherein the light transmitting layer is transparent to visible light.

Example embodiment 9: The substrate of embodiment 8, wherein the light transmitting layer is selected from glass or thermoplastic.

Example embodiment 10: The substrate of embodiment 8, wherein the light transmitting layer is selected from polycarbonate, polycarbonate copolymers, polyesters, polyester carbonate copolymers or poly(methyl methacrylate.

Example embodiment 11: The substrate of any of the embodiments 1-10, wherein the light reflecting layer provides either specular or diffuse reflection.

Example embodiment 12: The substrate of any of the embodiments 1-11, wherein the light reflecting layer is selected from metal or metal oxide.

Example embodiment 13: The substrate of embodiment wherein the metal is selected from gold, silver, aluminum or combinations thereof.

Example embodiment 14: The substrate of embodiment 11, wherein the light reflecting layer comprises silver, the layer thickness being 10 nm-500 nm, preferably 20 nm-150 nm and more preferably 20-100 nm.

Example embodiment 15: The substrate of any of the embodiments 1-10, wherein the light reflecting layer provides diffuse reflection.

Example embodiment 16: The substrate of embodiment 15, wherein the light reflecting layer is selected from a metal oxide such as titanium oxide or a mixed metal oxide.

Example embodiment 17: The substrate of any of the embodiments 1-16, wherein each of the subdivisions is circular in shape.

Example embodiment 18: The substrate of embodiment 17, wherein each of the subdivisions has a diameter of greater than 5 micron, preferably greater than 10 microns and more preferably greater than 25 microns.

Example embodiment 19: The substrate of any of the embodiments 1-18, wherein the subdivisions are arranged in a plurality of rows.

Example embodiment 20: The substrate of embodiment 19, wherein the rows are spaced apart from one another at a distance from 0.01 mm to 0.1 mm, and more preferably 0.03 mm to 0.07 mm.

Example embodiment 21: The substrate of any of the embodiments 1-20, wherein the subdivision thickness ranges from 70% of the light reflecting layer thickness, and preferably to 50% of the reflecting layer thickness, and more preferably to 30% of the reflecting layer thickness and even more preferably to 0% of the reflecting layer thickness.

Example embodiment 22: The substrate of any of the embodiments 1-21, wherein the light transmitting layer comprises a light absorbing additive.

Example embodiment 23: The substrate of embodiment 22, wherein the light absorbing additive is selected from organic dyes including polycyclic organic compounds such as perylenes, nanoscaled compounds metal complexes including metal oxides, mixed metal oxides, complex oxides, metal-sulphides, metal-borides, metal-phosphates, metal-carbonates, metal-sulphates, metal-nitrides, lanthanum hexaboride, cesium tungsten oxide, indium in oxide, antimony in oxide, indium zinc oxide, or combinations thereof; azos, di-azos, quinacridones, perylenes, naphthalene tetracarboxylic acids, flavanthrones, isoindolinones, tetrachloroisoindolinones, anthraquinones, enthrones, dioxazines, phthalocyanines, azo lakes, Pigment Red 101, Pigment Red 122, Pigment Red 149, Pigment Red 177, Pigment Red 179, Pigment Red 202, Pigment Violet 29, Pigment Blue 15, Pigment Blue 60, Pigment Green 7, Pigment Yellow 119, Pigment Yellow 147, Pigment Yellow 150, and Pigment Brown 24; dyes including coumarin dyes, coumarin 460 (blue), coumarin 6 (green), nile red, hydrocarbon and substituted hydrocarbon dyes, polycyclic aromatic hydrocarbon dyes, scintillation dyes including oxazole or oxadiazole dyes, aryl- or heteroaryl-substituted poly (C2-8) olefin dyes, carbocyanine dyes, indanthrone dyes, phthalocyanine dyes, oxazine dyes, carbostyryl dyes, napthalenetetracarboxylic acid dyes, porphyrin dyes, bis(styryl)biphenyl dyes, acridine dyes, anthraquinone dyes, cyanine dyes, methine dyes, arylmethane dyes, azo dyes, indigoid dyes, thioindigoid dyes, diazonium dyes, nitro dyes, quinone imine dyes, aminoketone dyes, tetrazolium dyes, thiazole dyes, perylene dyes, perinone dyes, bis-benzoxazolylthiophene (BBOT), triarylmethane dyes, xanthene dyes, thioxanthene dyes, naphthalimide dyes, lactone dyes or combinations thereof.

The invention further encompasses a method of manufacturing a substrate for controlling transmission of incident light therethrough, and includes at least the following embodiments:

Example embodiment 24: A method of manufacturing a substrate for controlling transmission of incident light therethrough, the incident light including visible light and infrared light, the substrate comprising a light transmitting layer having a surface and a light reflecting layer positioned on the surface, the light reflecting layer having a layer thickness, the method comprising:
forming a plurality of subdivisions in the light reflecting layer, each of the subdivisions having a subdivision thickness less than the layer thickness and an area;
spacing each of the subdivisions from an adjacent subdivision by a spacing distance;
coordinating the layer thickness, the subdivision thickness, the area and the spacing distance so as to permit from 15% to 75% of the visible light to be transmitted through the substrate.

Example embodiment 25: The method of embodiment 24, further comprising coordinating the layer thickness, the subdivision thickness, the surface area and the spacing distance so as to permit transmission of from 18% to 73% of the visible light through the substrate.

Example embodiment 26: The method of either of the embodiments 24 or 25, further comprising coordinating the layer thickness, the subdivision thickness, the surface area and the spacing distance so as to permit transmission of from 20% to 80% of said incident light through said substrate.

Example embodiment 27: The method of any of the embodiments 24 through 26, further comprising coordinating the layer thickness, the subdivision thickness, the surface area and the spacing distance so as to permit transmission of from 15% to 70% of the incident light through the substrate.

Example embodiment 28: The method of either of the embodiments 24 or 25, further comprising coordinating the layer thickness, the subdivision thickness, the surface area and the spacing distance so as to cause from 20% to 80% of the incident light to be reflected from the substrate.

Example embodiment 29: The method of any of the embodiments 24 through 28, further comprising forming the subdivision thickness from 70% of the light reflecting layer thickness, and preferably to 50% of the reflecting layer thickness, and more preferably to 30% of the reflecting layer thickness and even more preferably to 0% of the reflecting layer thickness.

Example embodiment 30: The method of any of the embodiments 24 through 29, further comprising forming each of the subdivisions into a circular shape.

Example embodiment 31: The method of embodiment 30, further comprising forming each of the subdivisions into a circular shape having a diameter of greater than 5 micron, preferably greater than 10 microns and more preferably greater than 25 microns.

Example embodiment 32: The method of any of the embodiments 24 through 31, further comprising forming the subdivisions into a plurality of rows.

Example embodiment 33: The method of embodiment 32, further comprising spacing the rows apart from one another at a distance from 0.01 mm to 0.1 mm, and more preferably 0.03 mm to 0.07 mm.

Example embodiment 34: The method of any of the embodiments 24 through 33, wherein the subdivisions are formed by ablating the light reflecting layer.

Example embodiment 35: The method of embodiment 34, wherein the subdivisions are ablated by a laser.

Example embodiment 36: The method of embodiment 35, further comprising operating the laser at a wavelength between 150 nm and 1.064 microns.

Example embodiment 37: The method of embodiment 35, further comprising operating the laser at a wavelength between 150 nm and 1900 nm.

Example embodiment 38: The method of embodiment 35, further comprising operating the laser at a wavelength between 150 nm and 1200 nm.

Example embodiment 39: The method of embodiment 35, further comprising operating the laser at a wavelength between 150 nm and 600 nm.

Example embodiment 40: The method of embodiment 35, further comprising operating the laser at a wavelength of 355 nm.

Example embodiment 41: The method of any of the embodiments 35 through 40, further comprising operating the laser at a pulse frequency between 1 kHz-250 kHz, preferably 1 kHz-150 kHz.

Example embodiment 42: The method of any of the embodiments 35 through 40, further comprising forming the subdivisions by moving the substrate and the laser relatively to one another at a speed from 500 mm/sec to 10,000 mm/sec, and preferably 500 mm/sec to 5,000 mm/sec.

Example embodiment 43: The method of any of embodiments 24 through 41, further comprising affixing a light reflecting layer on a light transmitting layer.

### BRIEF DESCRIPTION OF THE DRAWINGS

FIG. 1 is a cross sectional view of an example embodiment of a substrate according to the invention;

FIG. 2 is a plan view of the substrate shown in FIG. 1; and

FIG. 3 is a flow chart describing an example method of manufacturing an example substrate.

### DETAILED DESCRIPTION

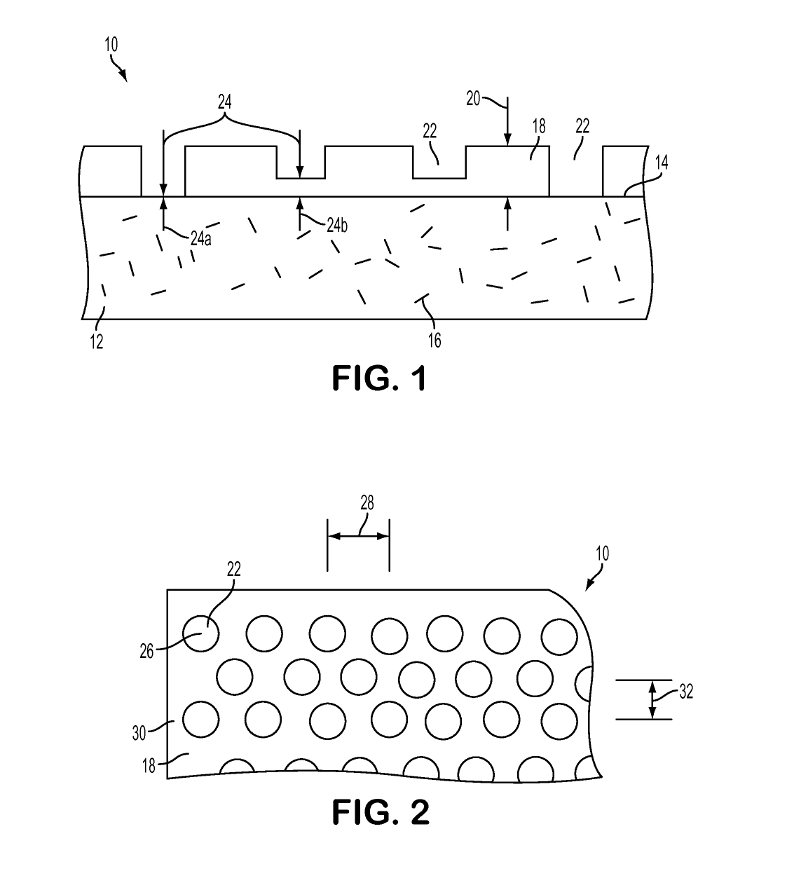

FIG. 1 shows an example embodiment of a substrate 10 for selectively controlling transmission of incident light. Substrate 10 comprises a light transmitting layer 12 having a surface 14. Light transmitting layer 12 may be formed, for example, from glass or a polymer such as a thermoplastic or thermoset and is transparent to visible light. Transparent is defined herein as a light transmittance of at least 80% when tested in the form of a 2 mm thick test sample (in its natural un-colored state) according to ASTM D10030 (hereby incorporated by reference). Light transmitting layer 12 may also comprise one or more light absorbing additives 16. Additives 16 may absorb in the infrared range, the visible range, and/or the ultra violet range of light. By way of example, infrared absorbing additives may comprise organic dyes including polycyclic organic compounds such as perylenes, nanoscaled compounds metal complexes including metal oxides, mixed metal oxides, complex oxides, metal-sulphides, metal-borides, metal-phosphates, metal-carbonates, metal-sulphates, metal-nitrides, lanthanum hexaboride, cesium tungsten oxide, indium in oxide, antimony in oxide, indium zinc oxide, or combinations thereof. Additionally by way of example, the additives that absorb in the visible and ultra violet ranges may include colorants such as pigment and/or dye additives, which can be present alone or in combination with UV absorbing stabilizers having little residual visible coloration in order to modulate the substrate color. Example pigments can include, organic pigments such as azos, di-azos, quinacridones, perylenes, naphthalene tetracarboxylic acids, flavanthrones, isoindolinones, tetrachloroisoindolinones, anthraquinones, enthrones, dioxazines, phthalocyanines, and azo lakes; Pigment Red 101, Pigment Red 122, Pigment Red 149, Pigment Red 177, Pigment Red 179, Pigment Red 202, Pigment Violet 29, Pigment Blue 15, Pigment Blue 60, Pigment Green 7, Pigment Yellow 119, Pigment Yellow 147, Pigment Yellow 150, and Pigment Brown 24; or combinations thereof. Exemplary dyes are generally organic materials and include coumarin dyes such as coumarin 460 (blue), coumarin 6 (green), nile red or the like; hydrocarbon and substituted hydrocarbon dyes; polycyclic aromatic hydrocarbon dyes; scintillation dyes such as oxazole or oxadiazole dyes; aryl- or heteroaryl-substituted poly (C2-8) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; naphthalimide dyes; lactone dyes or combinations thereof.

Thermoplastics such as polycarbonate, polycarbonate copolymers, polyesters, polyester carbonate copolymers, and poly(methyl methacrylate) are feasible example materials for substrate 10. A light reflecting layer 18 is positioned on the surface 14 of the light transmitting layer 12. Light reflecting layer 18 has a layer thickness 20 and may provide either specular or diffuse reflection. Light reflecting layer 18 may comprise an infrared reflecting layer. In specific example embodiments, the light reflecting layer 18 may comprise a metal, a metal oxide, a mixed metal oxide or a combination of both. Metals such as gold, silver, aluminum and combinations thereof are feasible, as are metal oxides such as titanium oxide and mixed metal oxides such as chrome titanate, nickel titanate, nickel antimony titanate. The use of metals is of advantage because it allows vacuum metallization techniques to be used to deposit thin reflecting layers of high accuracy and uniformity on the surface 14. In particular, it is expected that a silver reflecting layer having a thickness from about 10 nm to about 500 nm, or about 20 nm to about 150 nm, or about 20 nm to about 100 nm will be effective.

As shown in FIGS. 1 and 2, the light reflecting layer 18 comprises a plurality of subdivisions 22 arranged adjacent to one another. Each of the subdivisions 22 has a subdivision thickness 24 which can range from zero, (i.e., all of the reflecting layer removed as shown at subdivision thickness 24a) to a value greater than zero but less than the layer thickness 20 as shown at 24b. Subdivision thicknesses 24 ranging from 70% of the light reflecting layer thickness 20, to 50% of the light reflecting layer thickness, to 30% of the light reflecting layer thickness and down to 0% of the light reflecting layer thickness are considered feasible for a practical design. Each of the subdivisions 22 also has a surface area 26 and a spacing distance 28 indicative of the distance between adjacent subdivisions 22. In an example substrate 10 shown in FIG. 2, subdivisions 22 are circular in shape and are arranged in a plurality of rows 30. Rows 30 can also have a spacing distance 32 which can be the same as or different from the subdivision spacing distance 28. In practical applications of the invention, the subdivisions may have a diameter of greater than 5 microns, greater than 10 microns or greater than 25 microns. Furthermore, the subdivision spacing distance 28 can range from about 0.01 mm to about 0.1 mm, or from about 0.03 mm to about 0.07 mm. Additionally, the row spacing distance 32 can range from about 0.01 mm to about 0.1 mm, or from about 0.03 mm to about 0.07 mm.

By arranging the layer thickness 20 and subdivision parameters of subdivision thickness 24, surface area 26 and spacing distance 28, it is believed possible to form a substrate 10 which permits transmission of from about 15% to about 75% of the visible light through the substrate (as noted above, the visible light having wavelengths between about 380 nm to about 780 nm), or about 18% to about 73% of the visible light through the substrate. The various parameters of the layer thickness 20 and subdivision parameters of subdivision thickness 24, surface area 26 and spacing distance 28 may also be arranged so as to permit transmission of from about 20% to about 80% of the incident light through the substrate (as noted above, the incident light including both the visible and infrared, and having wavelengths between about 200 nm to about 2,500 nm), or from about 15% to about 70% of the incident light through the substrate.

By further arrangement of the layer thickness 20 and subdivision parameters of subdivision thickness 24, surface area 26 and spacing distance 28, it is believed possible to form a substrate 10 so as to cause from about 20% to about 80% of the incident light to be reflected from the substrate. It is also believed possible to arrange the layer thickness 20 and subdivision parameters of subdivision thickness 24, surface area 26 and spacing distance 28 to give a light to solar gain ratio (LSGR) greater than 1, where the light to solar gain ratio is defined as the ratio of visible light (Tvis) to the total solar transmission (TST); LSGR=Tvis/TST. LSGR is a useful parameter as it provides an index for characterizing the ability of a substrate to transmit visible light while rejecting heat. If LSGR is greater than 1 it signifies that the substrate transmits more light than heat, and is thus more efficient for illumination than for heat gain within an enclosed environment such as an automobile or a room in a glazed building.

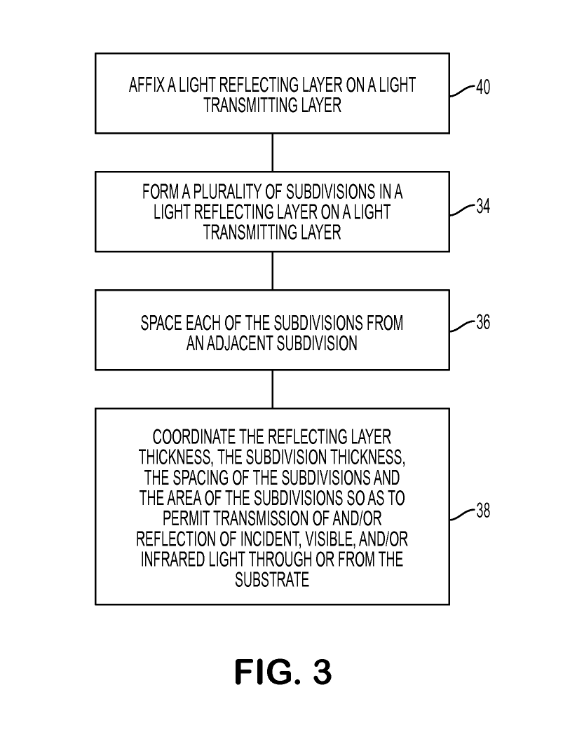

FIG. 3 shows a flow chart which illustrates an example method for manufacturing a substrate for controlling transmission of incident light therethrough. Using a light transmitting layer 12 having a light reflecting layer 18 positioned on a surface 14 of layer 12, the substrate 10 according to an example embodiment of the method is made by forming a plurality of subdivisions in the light reflecting layer 18 as noted at box 34 of FIG. 3. Formation of the subdivisions 22 (see FIGS. 1 and 2) is effected by removing some or all of the light reflecting layer 18 from the subdivision area 26. This will yield subdivisions 22 with subdivision thicknesses 24 less than the thickness 20 of the light reflecting layer 18. For practical designs, subdivision thicknesses 24 may range from 70% of the light reflecting layer thickness 20, to 50% of the light reflecting layer thickness, to 30% of the light reflecting layer thickness and down to 0% of the light reflecting layer thickness. In this example each subdivision 22 has a circular shape, although other shapes are also feasible. For circular subdivisions 22 the diameter may be greater than 5 microns, greater than 10 microns, or greater than 25 microns. As noted in Box 36, adjacent subdivisions 22 are also spaced apart from one another by a spacing distance 28, and could, for example, be arranged in a plurality of rows 30, the rows also having a spacing distance 32. The spacing distances 28 and 32 need not be uniform, but could vary, for example, as a function of position on the substrate 10. The subdivision spacing distance 28 can range from about 0.01 mm to about 0.1 mm, or from about 0.03 mm to about 0.07 mm. Additionally, the row spacing distance 32 can range from about 0.01 mm to about 0.1 mm, or from about 0.03 mm to about 0.07 mm. Both the subdivision spacing distance 28 and the row spacing distance 32 may both be generally considered “spacing distances” for practical purposes.

As shown in Box 38 of FIG. 3, the reflecting layer thickness 20, the subdivision thickness 24, the subdivision area 26 and the subdivision spacing distance (28 and 32) are then coordinated to permit transmission of and/or reflection of incident, visible, and/or infrared light through or from the substrate 10. By varying the aforementioned parameters, it is believed possible to form a substrate 10 which permits transmission of from about 15% to about 75% of the visible light through the substrate, or from about 18% to about 73% of the visible light through the substrate. The various parameters of the layer thickness 20 and subdivision parameters of subdivision thickness 24, surface area 26 and spacing distance 28 and 32 may also be coordinated so as to permit transmission of from about 20% to about 80% of the incident light through the substrate, or from about 15% to about 70% of the incident light through the substrate.

By further coordinating the layer thickness 20 and subdivision parameters of subdivision thickness 24, surface area 26 and spacing distance 28 and 32, it is believed possible to form a substrate 10 so as to cause from about 20% to about 80% of the incident light to be reflected from the substrate. It is also believed possible to coordinate the layer thickness 20 and subdivision parameters of subdivision thickness 24, surface area 26 and spacing distance 28 and 32 to give a light to solar gain ratio greater than 1, where the light to solar gain ratio is defined as the ratio of visible light (Tvis) to the incident light (TST, total solar transmission); LSGR=Tvis/TST.

As shown in box 40 of FIG. 3, the method may also include affixing a light reflecting layer on a light transmitting layer. This can be accomplished, for example, by vacuum deposition techniques when metals form the light reflecting layer, or by atomic layer deposition, printing or laminating techniques.

The subdivisions may be formed by ablating the light reflecting layer using, for example, a laser. While CO₂ and Nd:YAG lasers may be useful with certain substrate materials, there are advantages to using shorter wavelength lasers such as UV lasers and excimer lasers. UV and excimer lasers are less likely to cause charring or burning of thermoplastics comprising the light transmitting layer of the substrate. Furthermore, shorter wavelength lasers will also have better optical resolution due to their shorter wavelength. This will permit smaller subdivisions to be formed at closer spacing distances, as the theoretical optical resolution of a laser is twice the laser wavelength.

It is thought that a laser operating at a wavelength between 200 nm and 1.064 microns, or at a wavelength between 150 nm and 1900 nm, or at a wavelength between 150 nm and 1200 nm, or a wavelength between 150 nm and 600 nm, or at a wavelength of about 355 nm would be effective at forming subdivisions by ablation. Furthermore, the laser could be operated at a pulse frequency between 1 kHz and 250 kHz or between 1 kHz and 150 kHz. Arranging the subdivisions into rows could be effected by moving the substrate and laser relatively to one another at a speed from 500 mm/sec to about 10,000 mm/sec or from about 500 mm/sec to about 5,000 mm/sec.

### EXAMPLES

Five sample substrates were prepared by using a vacuum metallization technique to deposit a 50 nm layer of silver (the light reflecting layer) on each of five polycarbonate light transmitting layers formed of Lexan 8010 film, each light transmitting layer having a thickness of 0.6 mm. The silver coating procedure of the 0.6 mm Lexan 8010 film was carried out using a EVATEC BAK 501 under high vacuum. The procedure involves placing the samples in the chamber & initial pump down to <10⁻⁵ Mbar. A glow discharge pretreatment using air 10⁻¹ Mbar, 4 kV, which takes about 1 minute. Another pump down to <10⁻⁵ Mbar & thermal Silver evaporation in 1 min, building up Ag-layer of 50 nm.

Using a Trumark 6330 laser having an operating wavelength of 355 nm, the silver layer was ablated on four of the sample substrates to form a plurality of subdivisions arranged in a plurality of rows. The Trumark 6330 laser was used to selectively treat a 2.5 mm×2.5 mm area of the 50 nm silver coating from the 0.6 mm Lexan 8010 film by manipulating the frequency, speed & the fill factor i.e. the spacing between one line of subdivisions and the next line of subdivisions. Table 1 shows the laser parameters for each of the four samples which underwent laser ablation.

TABLE 1

| | Sample | Sample | Sample | Sample |
|---|---|---|---|---|
| | #1 | #2 | #3 | #4 |
| Laser Pulse Frequency (kHz) | 42 | 42 | 35 | 42 |
| Relative Speed (mm/sec) | 2975 | 2125 | 2450 | 1275 |
| Line spacing (mm) | 0.07 | 0.05 | 0.07 | 0.03 |

The laser pulse frequency determines the intensity of the laser, with higher pulse frequencies corresponding to lower intensity pulses. The relative speed parameter in Table 1 (also referred to as the beam displacement velocity) is the relative speed between the sample substrate and the laser. The combination of the pulse rate and the speed defines the subdivision spacing distance (item 28 in FIG. 1). The line spacing is the spacing distance between rows (item 32 in FIG. 2). The subdivisions had a diameter of 25 microns.

Table 2 shows the light transmission and reflection properties of the sample substrates compared with the reference sample which was not ablated. Ultraviolet, visible and near infrared spectra were obtained on the substrates using a PerkinElmer Lambda 950 with 150 mm integrating sphere in transmission and reflection mode over a wavelength range of 200-2500 nm with a 5 nm interval. Solar properties were calculated based on the ISO9050:2003 standard and the following were reported:

DST (direct solar transmission)

DSR (direct solar reflection)

Ae (direct solar absorption)

qi (secondary heat transfer to the inside)

TST (total solar transmission=DST+qi)

The measured parameters are defined as follows:
Tvis=% of visible light transmitted through the substrate sample;
DSR=% of incident light reflected from sample (direct solar reflection);
DST=% of incident light transmitted through sample (direct solar transmission);
qi=secondary heat transfer factor from sample;
Ae=% direct solar absorption
TST=DST+qi (% total solar transmission).
LSGR=light to solar gain ratio and is defined as the ratio of visible light
(Tvis) to the total solar transmission (TST); LSGR=Tvis/TST

The total transmission to visible light (Tvis) was measured on a haze-gard dual from BYK-Gardener according to ASTM D 1003.

TABLE 2

| | Reference | Sample | Sample | Sample | Sample |
|---|---|---|---|---|---|
| | Sample | #1 | #2 | #3 | #4 |
| Tvis | 4.7 | 18.3 | 28.3 | 36.1 | 72.8 |
| DSR | 96 | 79.5 | 69.8 | 61.0 | 24.5 |
| DST | 3.1 | 16.1 | 26.0 | 33.9 | 69.5 |
| qi | 0.2 | 1.1 | 1.1 | 1.3 | 1.6 |
| Ae | 0.9 | 4.4 | 4.2 | 5 | 6.1 |
| TST | 3.4 | 17.3 | 27.1 | 35.2 | 71.0 |
| LSGR | 1.38 | 1.06 | 1.04 | 1.02 | 1.02 |

Results summarized in Table 2 indicate that it is possible to arrange the substrate parameters of reflecting layer thickness, subdivision thickness, surface area and the spacing distances to achieve transmission of 72.8% of the visible light (Tvis) (sample 4) while reflecting 24.5% of the incident light (DSR) and limiting the transmission of incident light (DST) to 69.4%.

What is claimed is:

1. A substrate for controlling transmission of incident light therethrough, said incident light including visible light and infrared light, said substrate comprising:
a light transmitting layer having a surface;
a light reflecting layer positioned on said surface of said light transmitting layer, said light reflecting layer having a layer thickness and comprising a plurality of subdivisions arranged adjacent to one another, each of said subdivisions having a subdivision thickness less than said layer thickness, each of said subdivisions having a surface area, each of said subdivisions being spaced from an adjacent subdivision by a spacing distance, said layer thickness, said subdivision thickness, said surface area and said spacing distance being arranged so as to permit transmission of from about 15% to about 75% of said visible light through said substrate.

2. The substrate according to claim 1, wherein said light reflecting layer comprises an infrared reflecting layer.

3. The substrate according to claim 1, wherein said layer thickness, said subdivision thickness, said surface area and said spacing distance are arranged so as to permit transmission of from about 18% to about 73% of said visible light through said substrate.

4. The substrate according to claim 1, wherein said layer thickness, said subdivision thickness, said surface area and said spacing distance are arranged so as to permit transmission of from about 20% to about 80% of said incident light through said substrate.

5. The substrate according to claim 1, wherein said layer thickness, said subdivision thickness, said surface area and said spacing distance are arranged so as to permit transmission of from about 15% to about 70% of said incident light through said substrate.

6. The substrate according to claim 1, wherein said layer thickness, said subdivision thickness, said surface area and said spacing distance are arranged so as to cause from about 20% to about 80% of said incident light to be reflected from said substrate.

7. The substrate according to claim 1, wherein said layer thickness, said subdivision thickness, said surface area and said spacing distance are arranged so as to give a light to solar gain ratio greater than one.

8. The substrate according to claim 1, wherein said light transmitting layer is selected from glass or thermoplastic.

9. The substrate according to claim 1, wherein said light transmitting layer is selected from polycarbonate, polycarbonate copolymers, polyesters, polyester carbonate copolymers or poly(methyl methacrylate).

10. The substrate according to claim 1, wherein said light reflecting layer is selected from metal, a metal oxide or a mixed metal oxide.

11. The substrate according to claim 10, wherein said metal is selected from gold, silver, aluminum or combinations thereof.

12. The substrate according to claim 11, wherein said light reflecting layer comprises silver, said layer thickness being from about 10 nm to about 500 nm.

13. The substrate according to claim 1, wherein said subdivision thickness is from about 70% of said reflecting layer thickness to about 0% of the reflecting layer thickness.

14. The substrate according to claim 1 wherein the light transmitting layer comprises a light absorbing additive.

15. The substrate according to claim 14 wherein the light absorbing additive is selected from organic dyes including polycyclic organic compounds such as perylenes, nanoscaled compounds metal complexes including metal oxides, mixed metal oxides, complex oxides, metal-sulphides, metal-borides, metal-phosphates, metal-carbonates, metal-sulphates, metal-nitrides, lanthanum hexaboride, cesium tungsten oxide, indium in oxide, antimony in oxide, indium zinc oxide, or combinations thereof.

16. The substrate according to claim 14, wherein the light absorbing additive is selected from organic pigments including azos, di-azos, quinacridones, perylenes, naphthalene tetracarboxylic acids, flavanthrones, isoindolinones, tetrachloroisoindolinones, anthraquinones, enthrones, dioxazines, phthalocyanines, azo lakes, Pigment Red 101, Pigment Red 122, Pigment Red 149, Pigment Red 177, Pigment Red 179, Pigment Red 202, Pigment Violet 29, Pigment Blue 15, Pigment Blue 60, Pigment Green 7, Pigment Yellow 119, Pigment Yellow 147, Pigment Yellow 150, and Pigment Brown 24; dyes including coumarin dyes, coumarin 460 (blue), coumarin 6 (green), nile red, hydrocarbon and substituted hydrocarbon dyes, polycyclic aromatic hydrocarbon dyes, scintillation dyes including oxazole or oxadiazole dyes, aryl- or heteroaryl-substituted poly (C2-8) olefin dyes, carbocyanine dyes, indanthrone dyes, phthalocyanine dyes, oxazine dyes, carbostyryl dyes, napthalenetetracarboxylic acid dyes, porphyrin dyes, bis(styryl)biphenyl dyes, acridine dyes, anthraquinone dyes, cyanine dyes, methine dyes, arylmethane dyes, azo dyes, indigoid dyes, thioindigoid dyes, diazonium dyes, nitro dyes, quinone imine dyes, aminoketone dyes, tetrazolium dyes, thiazole dyes, perylene dyes, perinone dyes, bis-benzoxazolylthiophene (BBOT), triarylmethane dyes, xanthene dyes, thioxanthene dyes, naphthalimide dyes, lactone dyes or combinations thereof.

17. A method of manufacturing a substrate for controlling transmission of incident light therethrough, said incident light including visible light and infrared light, said substrate comprising a light transmitting layer having a surface and a light reflecting layer positioned on said surface, said light reflecting layer having a layer thickness, said method comprising:
forming a plurality of subdivisions in said light reflecting layer, each of said subdivisions having a subdivision thickness less than said layer thickness and an area;
spacing each of said subdivisions from an adjacent subdivision by a spacing distance;
coordinating said layer thickness, said subdivision thickness, said area and said spacing distance so as to permit from about 15% to about 75% of said visible light to be transmitted through said substrate.

18. The method according to claim 17, further comprising coordinating said layer thickness, said subdivision thickness, said surface area and said spacing distance so as to permit transmission of from about 18% to about 73% of said visible light through said substrate.

19. The method according to claim 17, further comprising coordinating said layer thickness, said subdivision thickness, said surface area and said spacing distance so as to permit transmission of from about 20% to about 80% of said incident light through said substrate.

20. The method according to claim 17, further comprising coordinating said layer thickness, said subdivision thickness, said surface area and said spacing distance so as to permit transmission of from about 15% to about 70% of said incident light through said substrate.

21. The method according to claim 17, further comprising coordinating said layer thickness, said subdivision thickness, said surface area and said spacing distance so as to cause from about 20% to about 80% of said incident light to be reflected from said substrate.

22. The method according to claim 17, wherein said subdivisions are formed by ablating said light reflecting layer using a laser.

23. The method according to claim 22, further comprising operating said laser at a wavelength from about 150 nm to about 1.064 microns.

24. The method according to claim 22, further comprising operating said laser at a pulse frequency from about 1 kHz to about 250 kHz.

25. The method according to claim 22, further comprising forming said subdivisions by moving said substrate and said laser relatively to one another at a speed from about 500 mm/sec to about 10,000 mm/sec.

26. The method according to claim 17, further comprising affixing a light reflecting layer on a light transmitting layer.
